(19) United States
(12) Patent Application Publication
(10) Pub. No.: US 2025/0278641 A1
(43) Pub. Date: Sep. 4, 2025

(54) HUMAN-COMPUTER DIALOGUE METHOD AND APPARATUS, AND ELECTRONIC DEVICE

(71) Applicant: Lenovo (Beijing) Limited, Beijing (CN)

(72) Inventors: Xinyu ZHOU, Beijing (CN); Jingwei SUN, Beijing (CN); Meng WU, Beijing (CN)

(21) Appl. No.: 19/035,788

(22) Filed: Jan. 23, 2025

(30) Foreign Application Priority Data
Feb. 29, 2024 (CN) 202410231933.5

(51) Int. Cl. G06N 5/02

(52) U.S. Cl. CPC G06N 5/02

(57) ABSTRACT

A human-computer dialogue method includes receiving input data from a user, generating, based on the input data, entity data at least representing an object included in the input data, sending to a personal database a query request including the entity data, receiving cognitive data, sent by the personal database, corresponding to the entity data and representing a cognitive level of the user regarding the entity data, determining an output result based on the entity data and the cognitive data, and outputting the output result.

### CROSS-REFERENCE TO RELATED DISCLOSURE

This application claims priority to Chinese Patent Application No. 202410231933.5, filed on Feb. 29, 2024, the entire content of which is incorporated herein by reference.

### TECHNICAL FIELD

The present disclosure generally relates to the field of data processing and deep learning technologies and, more particularly, to a human-computer dialogue method and apparatus, and an electronic device.

### BACKGROUND

During the communication between artificial intelligence (AI) and a user, there is a cognitive gap between the user and AI because of the user's different personal knowledge backgrounds and life experiences, which will affect the communication efficiency between the user and AI. To better communicate, it is needed to align the cognition of AI with that of the user, that is, to use AI to determine the cognitive level of the user and then give appropriate responses based on the cognitive level of the user.

### SUMMARY

In accordance with the disclosure, there is provided a human-computer dialogue method including receiving input data from a user, generating, based on the input data, entity data at least representing an object included in the input data, sending to a personal database a query request including the entity data, receiving cognitive data, sent by the personal database, corresponding to the entity data and representing a cognitive level of the user regarding the entity data, determining an output result based on the entity data and the cognitive data, and outputting the output result.

Also in accordance with the disclosure, there is provided an electronic device including an input/output system, a memory storing instructions, and a processor configured to execute the instructions to receive, through the input/output system, input data from a user, generate, based on the input data, entity data at least representing an object included in the input data; send, through the input/output system to a personal database, a query request including the entity data, receive, through the input/output system, cognitive data, sent by the personal database, corresponding to the entity data and representing a cognitive level of the user regarding the entity data, determine an output result based on the entity data and the cognitive data, and output the output result through the input/output system.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

In the drawings, the same or corresponding reference numerals indicate the same or corresponding parts.

FIG. 1 is a flowchart of a human-computer dialogue method consistent with embodiments of the present disclosure.

FIG. 2 is a flowchart of another human-computer dialogue method consistent with embodiments of the present disclosure.

FIG. 3 is a flowchart of another human-computer dialogue method consistent with embodiments of the present disclosure.

FIG. 4 is a flowchart of another human-computer dialogue method consistent with embodiments of the present disclosure.

FIG. 5 is a schematic diagram illustrating human-computer dialogue consistent with embodiments of the present disclosure.

FIG. 6 is a schematic structural diagram of a human-computer dialogue apparatus consistent with embodiments of the present disclosure.

FIG. 7 is a schematic structural diagram of an electronic device consistent with embodiments of the present disclosure.

### DETAILED DESCRIPTION OF THE EMBODIMENTS

Embodiments of the present disclosure will be described below in connection with the drawings. Obviously, the described embodiments are only part of the embodiments of the present disclosure, but not all of the embodiments. Based on the embodiments described in the present disclosure, all other embodiments obtained by those skilled in the art without making creative work are within the scope of the present disclosure.

At present, a user needs to declare his cognitive level or cognition of a certain entity to AI, which requires the user to input a lot of content, and it is difficult for the user to express his own cognitive level, resulting in poor user experience and poor cognitive alignment effect.

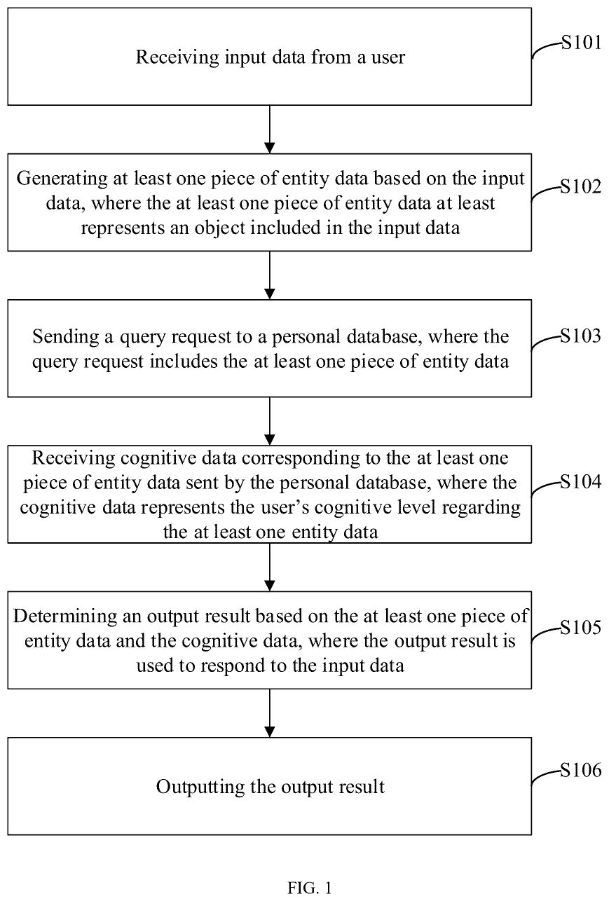

To accurately determine the user's cognitive level without the need for user input and accurately communicate with the user based on the user's cognitive level, the present disclosure provides a human-computer dialogue method. As shown in FIG. 1, in one embodiment, the method includes S101 to S106.

At S101, input data from the user is obtained.

The user's input data may be text data entered by the user through a keyboard, voice data entered through a microphone, or video data entered through a camera, etc.

A S102, at least one piece of entity data is generated based on the input data, where the entity data at least represents an object included in the input data.

At least one piece of entity data may be generated based on the input data. The entity data may be an object included in the input data (such as a person's name, a place name, an item, etc.).

For the input data in text format, the entity data may be obtained from the input data by entity recognition, keyword extraction, etc. For the input data in voice or video formats, the input data may be first converted into data in text format by voice recognition, and then the entity data may be obtained from the data in text format by entity recognition, keyword extraction, etc.

The at least one piece of entity data may also be generated by natural language understanding of the input data.

For example, in one embodiment, the input data is “red round fruit,” and the entity data such as “apple,” “tomato,” or “cherry” is obtained by natural language understanding of the input data.

At S103, a query request is sent to a personal database, where the query request includes the at least one piece of entity data.

The at least one piece of entity data generated based on the input data may be encapsulated into the query request which is sent to the personal database.

In one embodiment, it may be needed to collect the user's behavior data in advance, and extract at least one piece of cognitive data of the user from the behavior data to form the personal database of the user. The cognitive data may be data in the form of vectors, knowledge graphs, etc.

At S104, the cognitive data corresponding to the at least one piece of entity data sent by the personal database is obtained, where the cognitive data represents the user's cognitive level regarding the corresponding entity data.

After receiving the query request, the personal database may be queried to find the corresponding cognitive data based on the at least one piece of entity data, and the found at least one piece of cognitive data corresponding to each piece of entity data is returned. The at least one piece of cognitive data corresponding to one piece of entity data may accurately represent the user's cognitive level regarding the entity data.

For example, the entity data “clear river” may be a river or a place name. When the relevant cognitive data “Clear River Subway Station” is found in the user's personal database, it may represents that in the user's cognition, “clear river” is the name of a subway station.

At S105, an output result is determined based on the at least one piece of entity data and the cognitive data, wherein the output result is used to respond to the input data.

The output result may be determined based on the at least one piece of cognitive data corresponding to each received entity data. The output result may be data in the form of text, voice, video or link.

For example, for the entity data “clear river,” the corresponding cognitive data may be “Clear River Subway Station,” and the output result may be determined as a navigation link for Clear River Subway Station.

At S106, the output result is output.

The output result may be output through a display screen, a speaker, etc. The output result may also be sent to a mobile device bound to the user's identity.

In the present disclosure, the personal database of the user may be constructed, and, after receiving the input data of the user, the at least one piece of entity data may be generated based on the input data. By sending the query request encapsulated based on the at least one piece of entity data to the personal database, the at least one piece of cognitive data of each piece of entity data returned by the personal database may be received, and the at least one piece of cognitive data may accurately represent the user's cognitive level regarding the corresponding entity data. Finally, the output result may be determined based on the entity data and the corresponding cognitive data to accurately communicate with the user based on the user's cognitive level.

In one embodiment, generating the at least one piece of entity data based on the input data may include:
performing text segmentation on the input data to generate the at least one piece of entity data.

For the input data in text format, after text segmentation, the entity data may be obtained from the input data by entity recognition, keyword extraction, etc. For the input data in voice and video format, the input data may be first converted into data in text format by voice recognition, and after text segmentation, the entity data may be obtained from the data in text format by entity recognition, keyword extraction, etc.

In some other embodiments, semantic understanding may be performed on the input data to generate the at least one piece of entity data.

The at least one piece of entity data may also be generated by natural language understanding of the input data.

For example, when the input data is “red round fruit,” the entity data such as “apple,” “tomato,” and “cherry” may be obtained by natural language understanding of the input data.

In the above embodiments, since the user's input data does not necessarily include the entity data, by performing natural language understanding on the user's input data, the corresponding entity data may be accurately generated when the input data does not include the entity data, thereby improving the stability and high availability of the human-computer dialogue method.

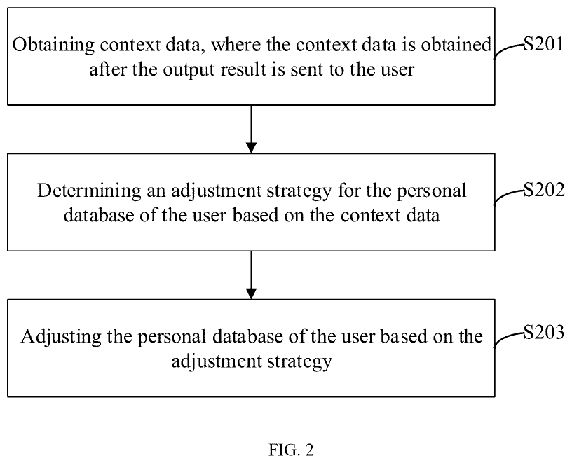

In another embodiment shown in FIG. 2, the human-computer dialogue method further includes S201 to S203.

At S201, context data is obtained, where the context data is obtained after the output result is sent to the user.

The context data may be obtained in multiple rounds of dialogue with the user after the output result is output.

At S202, an adjustment strategy of the user's personal database is determined based on the context data.

The context data may include information such as the user's evaluation or emotions on the output result. Therefore, the context data may represent the user's satisfaction with the output result. The adjustment strategy of the user's personal database may be determined based on the context data. When the user is satisfied with the output result, there may be no need to adjust the personal database. When the user is dissatisfied with the output result, the personal database may need to be adjusted based on the degree of dissatisfaction.

Step 203, the user's personal database is adjusted based on the adjustment strategy.

In one embodiment, the adjustment strategy of the user's personal database may be determined by the context data obtained in multiple rounds of dialogue with the user after the output result is output, and finally the user's personal database may be adjusted based on the adjustment strategy, which may continuously optimize the personal database during the dialogue with the user and further improve the accuracy of the output results in the human-computer dialogue with the user.

In the human-computer dialogue method provided by one embodiment, determining the adjustment strategy of the user's personal database based on the context data, may include:

determining the adjustment strategy to be a first adjustment strategy based on the context data, where the first adjustment strategy is used to be sent to the personal database such that the personal database adjusts at least one piece of cognitive data based on the context data.

FM (Foundation Model, a large language model) may be used to determine the label value of the output result based on the context data. When the difference between the label value of the output result and the output result is larger than or equal to a preset difference, the adjustment strategy may be determined to be the first adjustment strategy.

The personal database may receive the first adjustment strategy and the context data, and adjust at least one piece of cognitive data based on the context data.

In this embodiment, three methods may be used to adjust the cognitive data based on context data:

Method 1: adjust based on rules, where the adjustment rule is configured in advance, and the cognitive data is adjusted according to the matching degree of the rule.

For example, a rule may be formulated as: “create an emotional score of 0 points.” When negative emotional words appear in the context data, the emotional score may be reduced by a corresponding value based on the strength of the negative emotional words. After the final emotional score is determined, the cognitive data may be adjusted based on the emotional score.

Method 2: adjust based on similarity, where the similarity between the information and the output result is calculated based on the information related to the entity data in the context data, and the cognitive data is adjusted based on the similarity.

For example, the entity data is “Clear river,” and the output result is a navigation link of “Clear river Subway Station.” Based on multiple rounds of dialogues with the user, it may be determined that the information related to the entity data in the context data is “Clear river is a river.” Then, the similarity may be calculated based on “Clear river is a river” and “Clear river Subway Station,” and the cognitive data may be adjusted based on the similarity.

Method 3: adjust based on the reinforcement learning method, where: the current weights of multiple dimensions from the context data are determined, the target weight of each dimension is determined based on the current weight, historical weight and loss value of the output result of each dimension (calculated by inputting the output result and the label value of the output result into the loss function), the total weight is determined based on the target weights of these multiple dimensions, and the cognitive data may be adjusted based on the total weight.

Dimensions may include information interaction duration, information interaction time (the distance between the time of interaction and the current time), user interaction behavior (like, comment, analysis and/or collection), information modality significance (different formats of data have different significance, video>picture/audio>text), the number of information processed simultaneously, or at least one of user emotions.

The target weight Qᵢ of the i-th dimension may be determined based on the current weight and historical weight of the i-th dimension by the following formula:

$${Q}_{i} = {Q}_{i , 1} + α ( R - {Q}_{i , n} )$$

where, Q_{i,1} is the historical weight of the i-th dimension, Q_{i,n} is the current weight of the i-th dimension, α is the learning rate (in FM, it may be obtained through training), and R is the loss value of the output result.

The total weight Q may be then determined based on the target weights of multiple dimensions by the following formula:

$$Q = \frac{{\sum }_{i}^{n} {ω}_{i} {Q}_{i}}{n} ,$$

where, n is the total number of dimensions, ωᵢ is the weight of each dimension in the FM model (in FM, it can be obtained through training), and Qᵢ is the target weight of the i-th dimension.

After the total weight is obtained, the adjustment may be performed by weighting the corresponding cognitive data with the total weight.

Or, based on the context data, the adjustment strategy may be determined to be a second adjustment strategy, and the second adjustment strategy may be sent to the personal database, such that the personal database adjusts at least one piece of cognitive data based on the feedback data, where the feedback data is determined based on the context data.

Similarly, FM may be used to determine the label value of the output result based on the context data. When the difference between the label value of the output result and the output result is less than the preset difference and it is determined that the context data includes feedback data, the adjustment strategy may be determined to be the second adjustment strategy. The feedback data may be any data that is able to represent the user's satisfaction with the input result, such as comment data, emotional data, etc.

The personal database may receive the second adjustment strategy and feedback data, and adjust at least one piece of cognitive data based on the feedback data.

For example, the feedback data may be “Your answer is wrong. The Clear river I mentioned refers to the clear river subway station.” Therefore, the corresponding cognitive data may be adjusted based on the feedback data.

Or, the adjustment strategy may be determined to be a third adjustment strategy based on the context data, and the third adjustment strategy may be sent to the personal database, such that the personal database adjusts at least one piece of cognitive data based on at least one piece of expert data, where the expert data is collected based on the entity data.

Similarly, FM may be used to determine the label value of the output result based on the context data. When the difference between the label value of the output result and the output result is less than the preset difference but it is determined that the context data does not include the feedback data, the adjustment strategy may be determined to be the third adjustment strategy.

The personal database may receive the third adjustment strategy and entity data, collect the at least one piece of expert data related to the entity data, and adjust the at least one piece of cognitive data based on the collected expert data.

For example, when the entity data is “Fourier transform,” the personal database may collect at least one piece of expert data related to “Fourier transform,” and adjust the relevant cognitive data based on the collected expert data.

In the above scheme, by determining the label value of the output result based on the context data, when the difference between the label value of the output result and the output result is large, that is, the difference is larger than or equal to the preset difference, the output result may be determined to be greatly different from the answer required by the user. Therefore, the adjustment strategy may be determined to be the first adjustment strategy, and at least one piece of cognitive data in the personal database may be adjusted based on the context data. When the difference between the label value of the output result and the output result is small, that is, the difference is less than the preset difference, the output result may be determined to be not much different from the answer required by the user. Therefore, it may be further determined whether there is feedback data in the context data. When there is the feedback data, at least one piece of cognitive data in the personal database may be adjusted based on the feedback data. When there is no feedback data, the expert data related to the entity data may be collected, and at least one piece of cognitive data in the personal database may be adjusted based on the expert data. It may be possible to continuously optimize the personal database more intelligently during the dialogue with the user, and further improve the accuracy of the output results in the human-computer dialogue with the user.

In the human-computer dialogue method provided by one embodiment of the present disclosure, the entity data may also represent the target information, emotional information and/or attribute information included in the input data.

The entity data may also represent the target information (such as learning advanced mathematics, etc.), the emotional information (such as happiness, sadness, etc.) and/or the attribute information (such as height, weight, etc.) included in the input data.

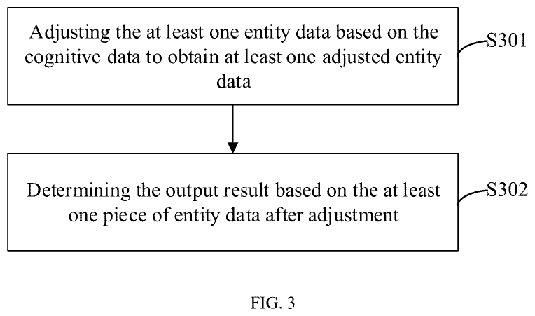

In the human-computer dialogue method provided by one embodiment of the present disclosure, as shown in FIG. 3, determining the output result based on the at least one piece of entity data and the cognitive data, includes S301 and S302.

At S301, the entity data is adjusted based on the cognitive data to obtain adjusted entity data.

In this embodiment, the entity data may be adjusted based on cognitive data in the following three manners.

The first manner may be feature connection, where feature connection may be performed on the cognitive data and entity data to generate a new feature vector.

For example, when the cognitive data is the user's education level (such as high school, undergraduate, master's degree, etc.), and the entity data is a mathematical problem, the cognitive data and entity data may be converted into one-hot encoding vectors, and then the one-hot encoding vectors of the cognitive data and entity data may be connected to generate a new feature vector, where the generated new feature vector may include the content of both cognitive data and entity data.

The second manner may be feature intersection, where feature intersection may be performed on the cognitive data and entity data using FM.

The third manner may be feature expansion, where some mathematical operations or conversions may be performed on the cognitive data and entity data to obtain a new feature vector.

For example, polynomial expansion may be performed on the cognitive data, and then element-by-element multiplication operations may be performed with the entity data to obtain a new feature vector.

At S302, the output result is determined based on the at least one piece of entity data after adjustment.

In the present embodiment, the entity data may be adjusted based on the cognitive data in a variety of ways, and the adjusted entity data may include the content of the cognitive data and entity data at the same time, making the subsequent output result determined based on the adjusted entity data more accurate.

In the human-computer dialogue method provided by one embodiment of the present disclosure, adjusting the entity data based on the cognitive data to obtain the adjusted entity data may include:

performing feature intersection on the cognitive data and the entity data to obtain the adjusted entity data.

In one embodiment, FM may be used to perform feature intersection on the cognitive data and entity data. The feature intersection on the cognitive data and entity data may be performed by the following formula to obtain the adjusted entity data xᵢ·xⱼ:

$${x}_{i} \cdot {x}_{j} = {v}_{i} \cdot {v}_{j} = {\sum }_{f = 1}^{k} {v}_{i , f} \cdot {v}_{j , f} ,$$

where, xᵢ is the feature vector of the cognitive data, xⱼ is the feature vector of the entity data, vᵢ is the latent vector of the feature vector of the cognitive data (obtained by training in FM), vⱼ is the latent vector of the feature vector of the entity data (obtained by training in FM), v_{i,f} is the f-th factor of the latent vector of the feature vector of the cognitive data, v_{j,f} is the f-th factor of the latent vector of the feature vector of the entity data, and k is the dimension of the latent vector.

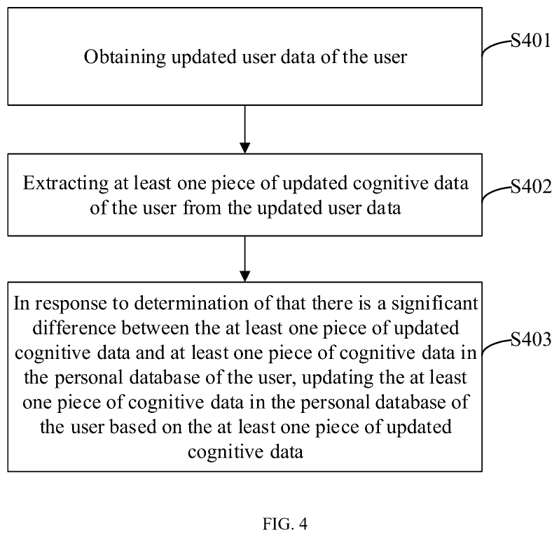

In the human-computer dialogue method provided by one embodiment of the present disclosure, as shown in FIG. 4, the method further includes S401 to S403.

At 401, updated user data of the user is obtained.

The updated user data of the user may be obtained regularly.

At S402, at least one piece of updated cognitive data of the user is extracted from the updated user data.

The at least one piece of updated cognitive data of the user may be extracted from the updated user data of the user.

At S403, in response to determining that there is a significant difference between the at least one piece of updated cognitive data and the at least one piece of cognitive data in the personal database of the user, the at least one piece of cognitive data in the personal database of the user is updated based on the at least one piece of updated cognitive data.

Whether there is a significant difference between the updated cognitive data and the cognitive data in the personal database of the user may be determined by calculating cosine similarity, Euclidean distance, Manhattan distance, etc.

When there is a significant difference, the cognitive data in the personal database of the user may be updated based on the updated cognitive data.

In the present embodiment, by regularly collecting the updated user data of the user and extracting the updated cognitive data from the updated user data, when it is determined that there is a significant difference between the updated cognitive data and the cognitive data in the personal database of the user, it may be determined the user's level of understanding of certain entity data has changed, and the cognitive data in the personal database of the user may be updated based on the updated cognitive data, which may continuously optimize the cognitive data in the personal database and further improve the accuracy of the cognitive data in the personal database.

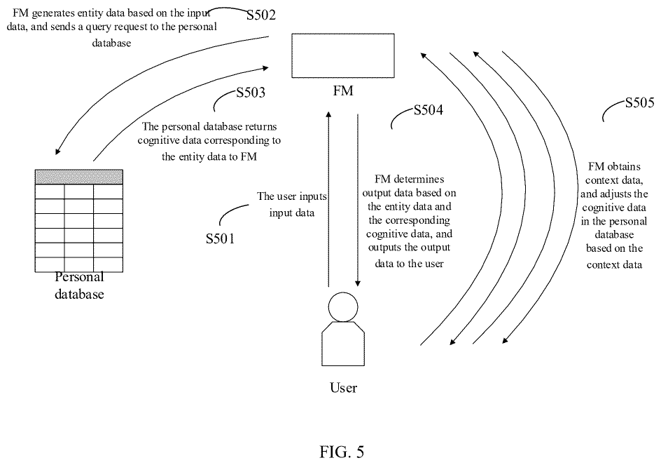

In another embodiment, as shown in FIG. 5, the human-computer dialogue method includes S501 to S505.

At S501, the user inputs input data.

At S502, FM generates entity data based on the input data, and sends a query request to the personal database.

FM may generate the entity data based on the input data, encapsulate the entity data into the query request, and send the query request to the personal database.

At S503, the personal database returns cognitive data corresponding to the entity data to FM.

The personal database may be queried to find the corresponding cognitive data based on the entity data, and the cognitive data may be returned to FM.

At S504, FM determines output data based on the entity data and the corresponding cognitive data, and outputs the output data to the user.

At S505, FM obtains context data, and adjusts the cognitive data in the personal database based on the context data.

FM may obtain the context data based on multiple rounds of dialogue with the user, and adjust the cognitive data in the personal database based on the context data.

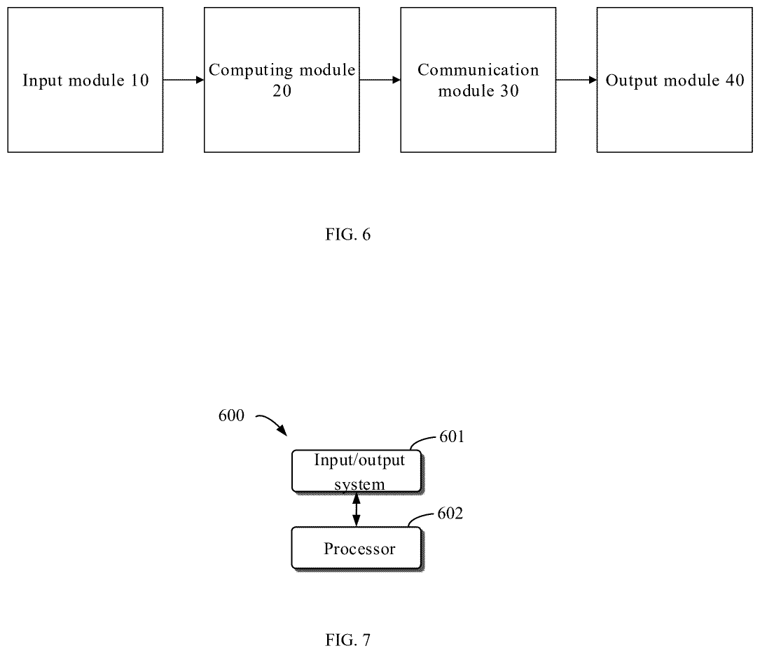

The present disclosure also provides a human-computer dialogue apparatus. As shown in FIG. 6, in one embodiment, the apparatus includes:
an input module 10, used to receive input data from a user;
a computing module 20, used to: generate at least one piece of entity data based on the input data, where the entity data at least represents an object included in the input data; and determine the output result based on the at least one piece of entity data and cognitive data, where the output result is used to respond to the input data;
a communication module 30, used to: send a query request to a personal database, where the query request includes the at least one piece of entity data; and receive the cognitive data corresponding to the at least one piece of entity data sent by the personal database, where the cognitive data represents the user's cognitive level regarding the corresponding entity data; and
an output module 40, used to output the output result.

The computing module 20 may also be used to: perform text segmentation on the input data to generate the at least one piece of entity data; and/or, perform semantic understanding on the input data to generate the at least one piece of entity data.

The input module 10 may also be used to obtain the context data, where the context data is obtained after the output result is sent to the user.

The computing module 20 may also be used to: determine an adjustment strategy of the user's personal database based on the context data; and adjust the user's personal database based on the adjustment strategy.

The computing module 20 may also be used to: determine that the adjustment strategy is a first adjustment strategy based on the context data, where the first adjustment strategy is sent to the personal database such that the personal database adjusts at least one piece of cognitive data based on the context data;
or, determine the adjustment strategy to be a second adjustment strategy based on the context data, where the second adjustment strategy is sent to the personal database such that the personal database adjusts at least one piece of cognitive data based on feedback data, where the feedback data is determined based on the context data;
or, determine the adjustment strategy to be a third adjustment strategy based on the context data, where the third adjustment strategy is sent to the personal database such that the personal database adjusts at least one piece of cognitive data based on at least one piece of expert data, where the expert data is collected based on the entity data.

The entity data may further characterize the target information, emotional information and/or attribute information included in the input data.

The computing module 20 may also be used to: adjust the entity data based on the cognitive data to obtain the adjusted entity data; and determine the output result based on the at least one piece of entity data after adjustment.

The computing module 20 may also be used to: perform feature intersection between the cognitive data and the entity data to obtain the adjusted entity data.

The input module 10 may also be used to obtain the updated user data of the user.

The computing module 20 may also be used to: extract at least one piece of updated cognitive data of the user from the updated user data; and, when it is determined that there is a significant difference between the at least one piece of updated cognitive data and the at least one piece of cognitive data in the personal database of the user, update the at least one piece of cognitive data in the personal database of the user based on the at least one piece of updated cognitive data.

The present disclosure also provides an electronic device and a readable storage medium.

FIG. 7 shows a schematic structural diagram of an example electronic device 600 that may be used to implement various embodiments of the present disclosure. The electronic device is intended to represent various forms of digital computers, such as laptop computers, desktop computers, workstations, personal digital assistants, servers, blade servers, mainframe computers, or other suitable computers. The electronic device may also represent various forms of mobile devices, such as personal digital processing, cellular phones, smart phones, wearable devices, or other similar computing devices. The components shown herein, their connections and relationships, and their functions are merely examples and are not intended to limit the implementation of the present disclosure described and/or required herein.

As shown in FIG. 7, the electronic device 600 includes an input/output system 601 and a processor 602, where the input/output system 601 and the processor 602 are electrically connected to each other.

The input/output system 601 may be configured to: receive input data from a user; transmit the input data to the processor 602; send the query request transmitted by the processor 602 to a personal database; receive the cognitive data corresponding to the at least one piece of entity data sent by the personal database; transmit the cognitive data corresponding to the at least one piece of entity data to the processor 602; receive the output data transmitted by the processor 602; and output the output data.

The processor 602 may be configured to receive the input data transmitted by the input/output system 601; generate the at least one piece of entity data based on the input data; transmit the at least one piece of entity data to the input/output system 601; receive the cognitive data corresponding to the at least one piece of entity data transmitted by the input/output system 601; determine the output result based on the at least one piece of entity data and the cognitive data; and transmit the output result to the input/output system 601.

The processor 602 may be further configured to: perform text segmentation on the input data to generate the at least one piece of entity data; and/or perform semantic understanding on the input data to generate the at least one piece of entity data.

The processor 602 may be further configured to: generate the query request based on the at least one piece of entity data; and transmit the query request to the input/output system 601.

The input/output system 601 may be further configured to obtain the context data and transmit the context data to the processor 602.

The processor 602 may be further configured to: determine an adjustment strategy for the user's personal database based on the context data; and adjust the user's personal database based on the adjustment strategy.

The processor 602 may be further configured to: determine that the adjustment strategy is the first adjustment strategy based on the context data, and transmit the first adjustment strategy to the input/output system 601; or, determine that the adjustment strategy is the second adjustment strategy based on the context data, and transmit the second adjustment strategy to the input/output system 601; or, determine that the adjustment strategy is the third adjustment strategy based on the context data, and transmit the third adjustment strategy to the input/output system 601.

The input/output system 601 may be further configured to: receive the first adjustment strategy transmitted by the processor 602, and send the first adjustment strategy to the personal database; or, receive the second adjustment strategy transmitted by the processor 602, and send the second adjustment strategy to the personal database; or, receive the third adjustment strategy transmitted by the processor 602, and send the third adjustment strategy to the personal database.

The processor 602 may be further configured to: adjust the entity data based on the cognitive data to obtain the adjusted entity data; and determine the output result based on the adjusted at least one piece of entity data.

The processor 602 may be further configured to perform feature intersection on the cognitive data and the entity data to obtain the adjusted entity data.

The input/output system 601 may be further configured to: obtain the updated user data of the user; transmit the updated user data to the processor 602. The processor 602 may be further configured to extract at least one piece of updated cognitive data of the user from the updated user data; determine that there is a significant difference between the at least one piece of updated cognitive data and at least one piece of cognitive data in the user's personal database, and then update the at least one piece of cognitive data in the user's personal database based on the at least one piece of updated cognitive data.

Various embodiments of the systems and techniques described above herein may be implemented in digital electronic circuit systems, integrated circuit systems, field programmable gate arrays (FPGAs), application specific integrated circuits (ASICs), application specific standard products (ASSPs), integrated systems on chips (SOCs), complex programmable logic devices (CPLDs), computer hardware, firmware, software, and/or combinations thereof. These various embodiments may include: being implemented in one or more computer programs that can be executed and/or interpreted on a programmable system including at least one programmable processor, which may be a dedicated or general-purpose programmable processor that can receive data and instructions from a storage system, at least one input device, and at least one output device, and transmit data and instructions to the storage system, the at least one input device, and the at least one output device.

The program code for implementing the methods disclosed herein may be written in any combination of one or more programming languages. These program codes may be provided to a processor or controller of a general-purpose computer, a dedicated computer, or other programmable data processing device, such that the program code, when executed by the processor or controller, causes the functions/operations specified in the flowchart and/or block diagram to be implemented. The program codes may be executed entirely on the machine, partially on the machine, partially on the machine and partially on a remote machine as a stand-alone software package, or entirely on a remote machine or server.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media would include electrical connections based on one or more wires, a portable computer disk, a hard disk, a random access memory (RAM), a read-only memory (ROM), an erasable programmable read-only memory (EPROM or flash memory), optical fiber, a portable compact disk read-only memory (CD-ROM), an optical storage device, a magnetic storage device, or any suitable combination thereof.

To provide interaction with a user, the systems and techniques described herein may be implemented on a computer having: a display device (e.g., a CRT (cathode ray tube) or LCD (liquid crystal display) monitor) for displaying information to the user; and a keyboard and pointing device (e.g., a mouse or trackball) through which the user can provide input to the computer. Other types of devices may also be used to provide interaction with the user; for example, the feedback provided to the user may be any form of sensory feedback (e.g., visual feedback, auditory feedback, or tactile feedback); and the input from the user may be received in any form (including acoustic input, voice input, or tactile input).

The systems and techniques described herein may be implemented in a computing system that includes a backend component (e.g., as a data server), or a computing system that includes a middleware component (e.g., an application server), or a computing system that includes a frontend component (e.g., a user computer with a graphical user interface or a web browser through which the user can interact with an implementation of the systems and techniques described herein), or a computing system that includes any combination of such backend components, middleware components, or frontend components. The components of the system may be interconnected by any form or medium of digital data communication (e.g., a communications network). Examples of communication networks include: local area networks (LANs), wide area networks (WANs), and the Internet.

A computer system may include a client and a server. The client and server may be generally remote from each other and usually interact through a communication network. The client-server relationship may be generated by computer programs running on corresponding computers and having a client-server relationship with each other. The server may be a cloud server, a server of a distributed system, or a server combined with a blockchain.

It should be understood that the various forms of processes shown above can be used to reorder, add, or delete steps. For example, the steps recorded in this disclosure may be executed in parallel, sequentially, or in different orders, as long as the desired results of the technical solutions disclosed in this disclosure can be achieved, and this document does not limit them here.

In addition, the terms “first” and “second” are used for descriptive purposes only, and cannot be understood as indicating or implying relative importance or implicitly indicating the number of technical features indicated. Thus, the features defined as “first” and “second” may explicitly or implicitly include at least one of the features. In the description of this disclosure, the meaning of “multiple” is two or more, unless otherwise clearly and specifically defined.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A human-computer dialogue method comprising:
receiving input data from a user;
generating entity data based on the input data, the entity data at least representing an object included in the input data;
sending a query request to a personal database, the query request including the entity data;
receiving cognitive data corresponding to the entity data and sent by the personal database, the cognitive data representing a cognitive level of the user regarding the entity data;
determining an output result based on the entity data and the cognitive data; and
outputting the output result.

2. The method according to claim 1, wherein generating the entity data based on the input data includes performing text segmentation on the input data to generate the entity data.

3. The method according to claim 1, wherein generating the entity data based on the input data includes performing semantic understanding on the input data to generate the entity data.

4. The method according to claim 1, further comprising:
obtaining context data the output result is sent to the user;
determining an adjustment strategy based on the context data; and
adjusting the personal database based on the adjustment strategy.

5. The method according to claim 4, wherein the adjustment strategy includes adjusting one or more pieces of cognitive data in the personal database based on the context data.

6. The method according to claim 4, wherein the adjustment strategy includes adjusting one or more pieces of cognitive data in the personal database based on feedback data determined based on the context data.

7. The method according to claim 4, wherein the adjustment strategy includes adjusting one or more pieces of cognitive data based on at least one piece of expert data collected based on the entity data.

8. The method according to claim 1, wherein the entity data further represents at least one of target information, emotion information, or attribute information included in the input data.

9. The method according to claim 1, wherein determining the output result includes:
adjusting the entity data based on the cognitive data to obtain adjusted entity data; and
determining the output result based on the adjusted entity data.

10. The method according to claim 9, wherein adjusting the entity data based on the cognitive data includes:
performing feature intersection between the cognitive data and the entity data to obtain the adjusted entity data.

11. The method according to claim 1, further comprising:
obtaining updated user data of the user;
extracting updated cognitive data of the user from the updated user data; and
in response to determination of that there is a significant difference between the updated cognitive data and one or more pieces of cognitive data in the personal database, updating the one or more pieces of cognitive data in the personal database based on the updated cognitive data.

12. An electronic device comprising:
an input/output system;
a memory storing instructions; and
a processor configured to execute the instructions to:
receive, through the input/output system, input data from a user;
generate entity data based on the input data, the entity data at least representing an object included in the input data;
send, through the input/output system, a query request to a personal database, the query request including the entity data;
receive, through the input/output system, cognitive data corresponding to the entity data and sent by the personal database, the cognitive data representing a cognitive level of the user regarding the entity data;
determine an output result based on the entity data and the cognitive data; and
output the output result through the input/output system.

13. The electronic device according to claim 12, wherein the processor is further configured to, when generating the entity data based on the input data, perform text segmentation on the input data to generate the entity data.

14. The electronic device according to claim 12, wherein the processor is further configured to, when generating the entity data based on the input data, perform semantic understanding on the input data to generate the entity data.

15. The electronic device according to claim 12, wherein the processor is further configured to:
obtain context data the output result is sent to the user;
determine an adjustment strategy based on the context data; and
adjust the personal database based on the adjustment strategy.

16. The electronic device according to claim 15, wherein the adjustment strategy includes adjusting one or more pieces of cognitive data in the personal database based on the context data.

17. The electronic device according to claim 15, wherein the adjustment strategy includes adjusting one or more pieces of cognitive data in the personal database based on feedback data determined based on the context data.

18. The electronic device according to claim 15, wherein the adjustment strategy includes adjusting one or more pieces of cognitive data based on at least one piece of expert data collected based on the entity data.

19. The electronic device according to claim 12, wherein the entity data further represents at least one of target information, emotion information, or attribute information included in the input data.

20. The electronic device according to claim 12, wherein the processor is further configured to, when determining the output result:
adjust the entity data based on the cognitive data to obtain adjusted entity data; and
determine the output result based on the adjusted entity data.
